(19) United States
(12) Patent Application Publication
(10) Pub. No.: US 2007/0289194 A1
(43) Pub. Date: Dec. 20, 2007

(54) WING FLAPPING COVER FOR DECOYS

(76) Inventor: DOUGLAS R. ALEXANDER, ARNOLDS PARK, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/673,805

(22) Filed: Feb. 12, 2007

Related U.S. Application Data
(63) Continuation-in-part of application No. 11/424,988, filed on Jun. 19, 2006.

(51) Int. Cl. A01M 31/06

(52) U.S. Cl. 43/3

(57) ABSTRACT

A flexible and removable covering for bird decoys for enhancing the lifelike appearance of the decoy in combination with an adjustable neck hole. A flexible fabric cover having the configuration of a plan view of the bird to be decoyed imprinted thereon is adapted for fitting over a rigid body bird decoy. It has a midline cut to allow the appearance of independent wing flapping of the bird. Thus, when viewed from above, the wings appear to be flapping in a breeze, creating even more lifelike appearance without the need for mechanical moving decoys, etc. The flexible fabric coverings are disposable and can be packaged conveniently for sale. The neck hole has a stretchable, yieldable band laminated to the cover to allow stretching without tearing.

### CROSS-REFERENCE TO RELATED APPLICATIONS

This application is a Continuation-in-Part of earlier filed U.S. Ser. No. 11/424,988 filed Jun. 19, 2006, Alexander, WING FLAPPING COVER FOR DECOYS. The benefit of the filing date is claimed herein.

### FIELD OF THE INVENTION

The field of the invention relates to bird decoys used to attract birds such as water fowl, and particularly ducks and geese.

### BACKGROUND OF THE INVENTION

Bird decoys have been used for at least two centuries to attract water fowl. The most common decoys initially were rigid floating wooden decoys painted to simulate the colors of the bird sought. Later, wood was replaced with less expensive materials for rigid decoys, such as fiber board material and in more recent times, lightweight plastic decoys. These are effective, but they are still rigid decoys lacking motion.

In recent times, it has become more popular to have in a spread of decoys, a select few mechanical decoys to provide wing flapping movement, as well as other movements such as diving, in order to provide more realism. All of this is in an effort to increase the chances of attracting flocks of birds to come into the decoy spread.

There have been some efforts in that past to provide decoy covers to enhance realism, see for example, U.S. Pat. No. 4,691,464 for a drawstring cover to be placed over worn decoys to enhance lifelike realism. Another more recent example is a polyethylene product sold under the trademark FLAPPERZ which has a flexible covering to be laid over for example, Canadian snow goose or duck decoys, with the covering having a feather print and its underside having white highlight coloration. This product uses a cumbersome mounting system and uses Velcro fasteners which often get wet or dirty and therefore cease to function. It also does not appear to be very lifelike in use as the “wings” of the flexible cover do not move independently in lifelike fashion.

It, therefore, can be seen that there is a continuing need for a realistic decoy cover which may be used over rigid decoys to provide a natural looking plan view of birds that appear to be realistically moving when viewed from above, i.e., the view that birds actually flying by see. My prior application addressed this need.

In use the embodiment of my prior application has revealed yet another problem that needs to be addressed. There is a substantial variation in the head size of many decoys, as a result the head hole in the decoy covering may have to be stretched, in some cases beyond its limit resulting in tearing. This happens for approximately 30% of the decoys encountered. This invention addresses this problem.

This invention has as its primary object the solving of the above referenced problem of my earlier invention.

Another object of the present invention is to improve upon the flexible covering of my prior application with an imprint of a plan view of a bird and which has a midline cut, preferably serrated, to allow the appearance of independent wing flapping and to easily allow the wind to grab the wings. The improved unit also has a head hole of variable diameter to allow easy placement over rigid decoys, without ripping.

A still further objective of the present invention is to provide disposable decoy covers which can be conveniently packaged with from 12 to 48 in each package, and which can be priced inexpensively to provide an incentive to replace them with new fresh looking ones from time to time. And which does this with an adjustable neck hole, which does not interfere with compact packaging.

The method and means of accomplishing the above objectives will become apparent from the detailed description of the invention and of the preferred embodiment which follow.

### BRIEF SUMMARY OF THE INVENTION

A flexible and removable covering for bird decoys for enhancing the lifelike appearance of the decoy in combination with an adjustable neck hole. A flexible fabric cover having the configuration of a plan view of the bird to be decoyed imprinted thereon is adapted for fitting over a rigid body bird decoy. It has a midline cut to allow the appearance of independent wing flapping of the bird. Thus, when viewed from above, the wings appear to be flapping in a breeze, creating even more lifelike appearance without the need for mechanical moving decoys, etc. The flexible fabric coverings are disposable and can be packaged conveniently for sale. The neck hole has a stretchable, yieldable band laminated to the cover to allow stretching without tearing and to assure that the cover stays oriented in the proper position.

### BRIEF DESCRIPTION OF THE DRAWINGS

FIG. 1 is a plan view of one of the removable flexible covers of the present invention with the improved stretchable neck hole.

FIG. 2 is a perspective view of a typical rigid decoy.

FIG. 3 is a partially schematic view showing how the improved flexible cover of the present invention may be inserted over the head and neck of a rigid decoy of FIG. 2.

FIG. 4 shows a decoy with the covering of FIG. 1 on it and facing into the wind with the wings independently flapping.

FIG. 5 shows a package of the flexible fabric covers, as ready for sale.

FIG. 6 shows a bottom view of the flexible cover of FIG. 1.

FIG. 7 shows a sectional view along line 7-7 of FIG. 1.

### DETAILED DESCRIPTION OF A PREFERRED EMBODIMENT

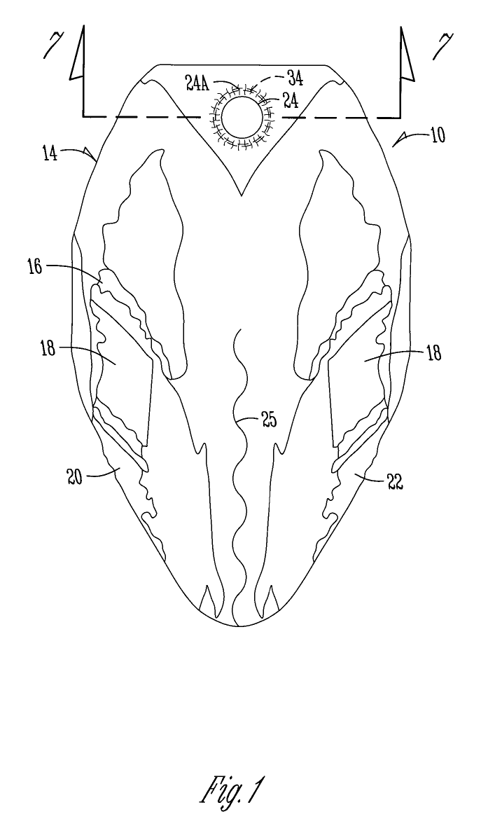

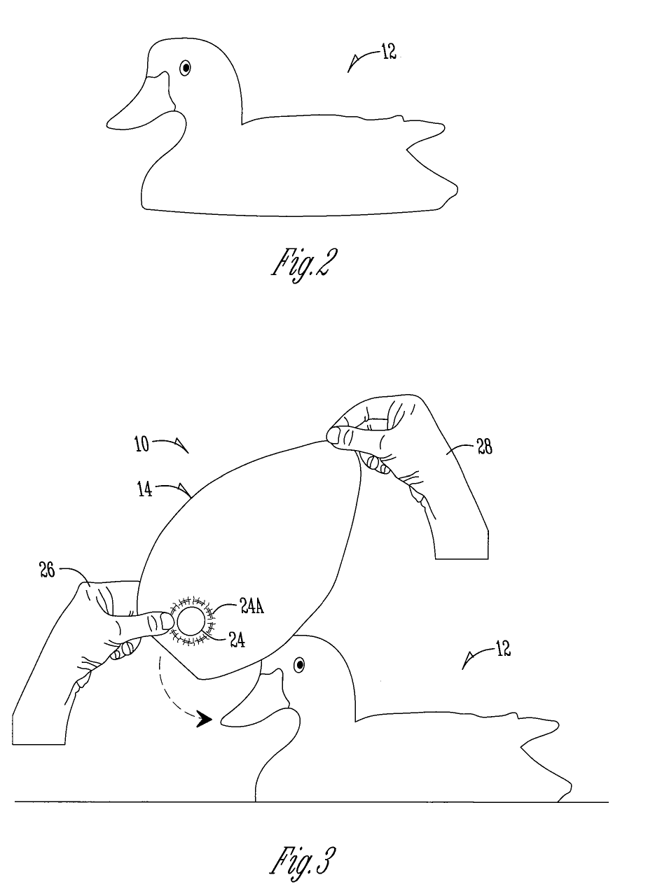

Referring now to the drawings, FIG. 1 is a plan view of one of the flexible coverings 10 of the present invention. FIG. 2 shows a perspective view of a conventional bird decoy, in this instance, a rigid body duck decoy 12 having one head, neck size. Of course other decoys may vary from this. Hence the need for variable diameter head holes 24. Looking back at FIG. 1, there is a flexible fabric 14 having the exterior shape 16 of a plan view of a duck 12. As illustrated by the drawing appearing on FIG. 1 designated by the numeral 16, there is an imprint on the fabric of a plan view of, in this instance, a mallard duck (shown by the drawing sketch) illustrated at 18. As seen by the imprint sketch 18, it shows both wing sides 20 and 22 of the duck. As also illustrated in FIG. 1, there is a head hole 24 for insertion over the head of decoy 12 and a midline cut 25 to allow independent wing flapping of the wing portions 20 and 22 as they catch any wind or breeze that might be occurring.

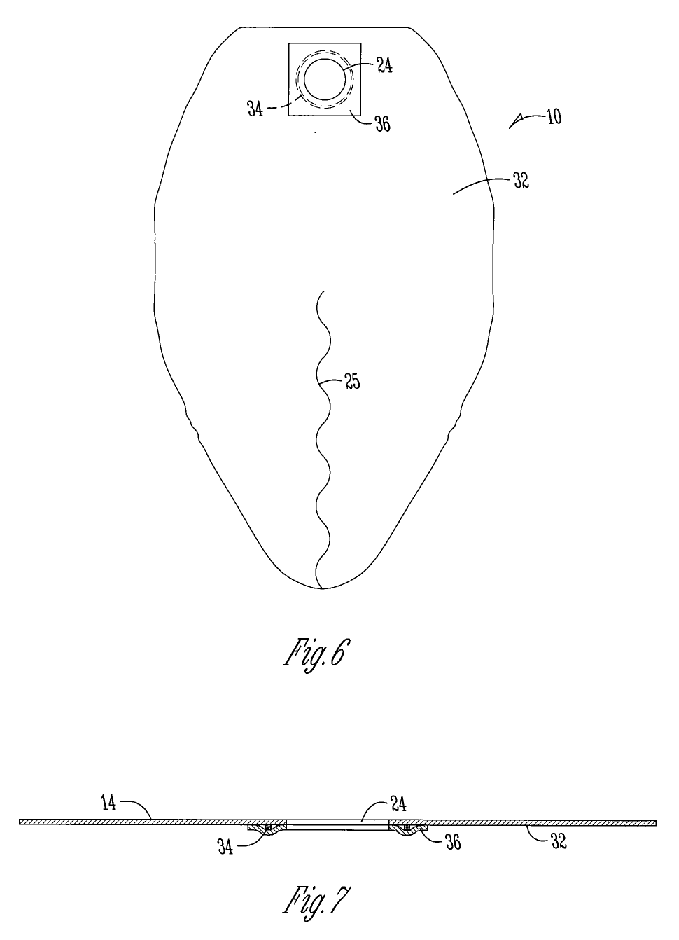

As illustrated in FIG. 1, the head hole 24, bears press marks 24a. The construction of the variable neck hole 24 is best illustrated in the bottom view of FIG. 6.

FIG. 6 shows the bottom 32 of flexible fabric 24. The fabric, as in my earlier application, is a polymeric alpha olefin, preferably polypropylene. Sitting around ad adjacent to hole 24 is a rubber band 34. This is then covered with another piece of fabric 36, having a lower melting point than fabric 24. The other piece of fabric 36 has a hole of similar size and dimension to head hole 24. A hot press is then put down to slightly melt other fabric 36 to cause it to stick to bottom 32 of flexible fabric cover 24. Upon cooling this sticks to fabric 24, sealing the rubber band 34 inside. As a result, head hole 24 can be stretched over various size decoy 12 heads without tearing flexible fabric 24, and fabric 24 is securely and yieldably held in place.

Generally it is preferred that fabric 36 be a mixture of polyethylene and polypropylene, preferably 5% polypropylene and 95% polyethylene, and that the hot press be held down for from about 2 seconds at a temperature of 140° C. The application of the small plastic sheet 36 around the rubber band 34 is a two-step process. First, the inside of the rubber band 34 (surface closest to the hole) is melted at the 140° C. for 2 seconds. Second, the outside of the rubber band 34 (surface going away from the hole, outside the rubber band), is melted at the 140° C. for 2 seconds. Both steps are enough heat to bond the plastic sheets and not destroy them, or the rubber band.

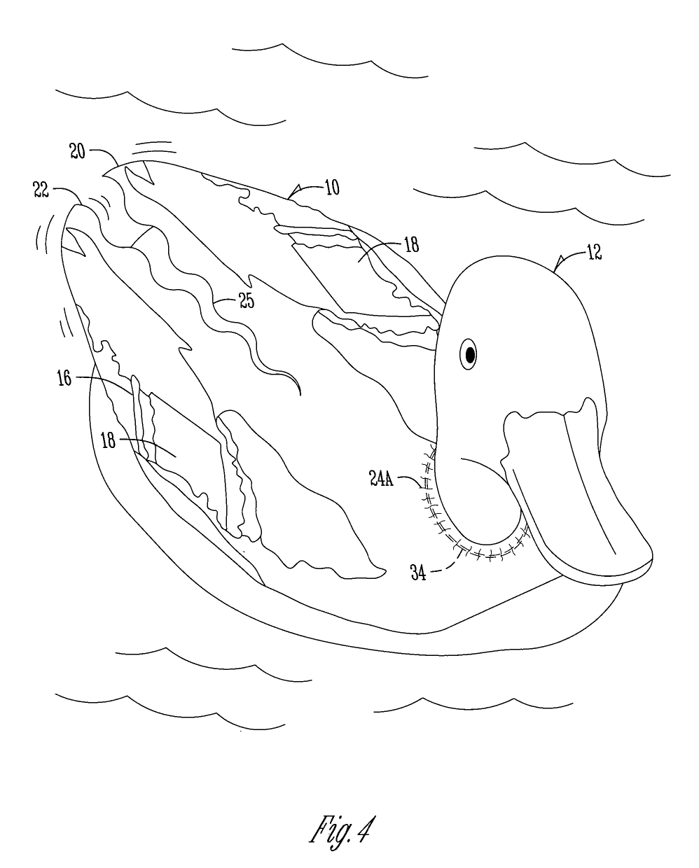

FIG. 3 illustrates how the flexible fabric covering 10 is inserted on the rigid decoy 12. The hunter, whose hands are illustrated at 26 and 28, grabs the cover 10 between the thumb and the index finger, gripping the front center. With the other hand 28, flexible cover 10 is pulled via hole 24 over the beak and head of decoy 12. The imprint image represented at 18 rests over the back of decoy 12. The decoy will naturally point facing into the wind, as shown at FIG. 4 and because of the midpoint or midline cut 26, each of the wings 20 and 22 can independently flap. Therefore, when viewed above, the decoys will appear to move, simulating movements of ducks as they preen and feed. The appearance is thus, far more lifelike than simply using a rigid painted decoy 12.

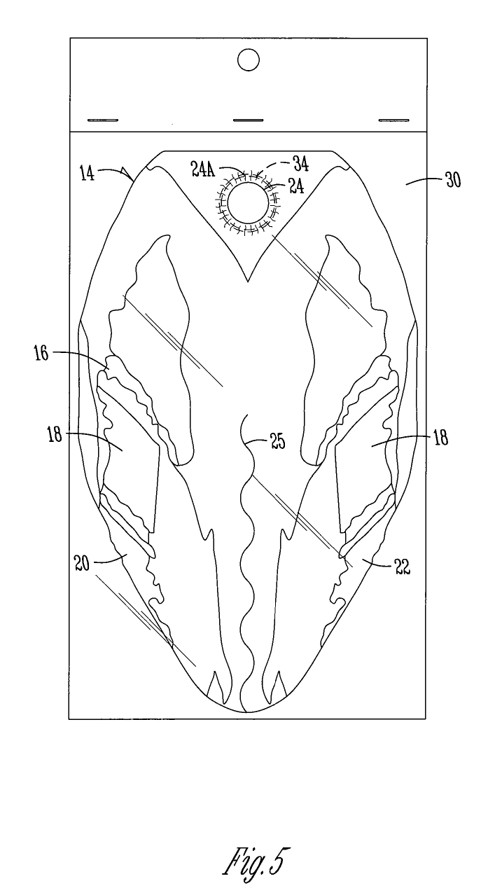

As seen in FIG. 5, the decoy imprints 10 can be conveniently packaged in a disposable package 30, typically twelve or ninety-six to a package. They may be made of stretchable polymeric plastic material, preferably a polymeric alpha-olefin and most preferably polypropylene which seems to work best. This material will still flap like wings even when wet. The units can be priced inexpensively and because of this can be treated as low cost and disposable, requiring purchase of new sets from time to time. They also can have in the same package, a mixture of males and females of the species to be attracted or can be selectively packaged all males or all females. Importantly the flexible neck hole improvement herein defined does not interfere with packaging.

While the description herein has been given primarily with puddle duck decoys using as an illustration the mallard, this is by way of example only. It can be used for all legally huntable birds, including ducks, geese, cranes, etc.

It can therefore be seen that the invention accomplishes at least all of its stated objectives.

What is claimed is:

1. A removable covering for a bird decoy, comprising:
a flexible fabric having the configuration of a plan view of the bird to be decoyed imprinted thereon;
said fabric having an adjustable head hole for insertion over the head of a decoy.

2. The removable covering of claim 1 which is a stretchable flexible fabric.

3. The removable covering of claim 2 which is made of polymeric plastic material.

4. The removable covering of claim 3 which is made of an alpha-olefin polymeric plastic material.

5. The removable cover of claim 4 which is made of polypropylene.

6. The removable cover of claim 5 wherein the flexible fabric cover has a mid line cut to allow independent wing flapping.

7. The removable covering of claim 1 wherein the adjustable head hole comprised a hole in the flexible cover, and an elastomeric band laminated to the flexible covering.

8. The removable covering of claim 7 wherein the elastomeric band is laminated to the flexible covering with a different, lower melting point flexible material.

9. The flexible covering of claim 8 wherein the elastomeric material is a rubber band.

10. A bird decoy in combination with a removable and flappable, flexible covering, comprising:
a rigid decoy having the shape of the bird to be decoyed; and
covering the top portion of said decoy, a flexible fabric having the configuration of a plan view of the bird to be decoyed imprinted thereon and having a flexible and adjustable neck hole;
said covering having a mid line cut to allow independent wing flapping in the wind.

11. The removable and flappable, flexible covering of claim 10 which is a stretchable flexible fabric.

12. The removable and flappable, flexible covering of claim 11 which is made of polymeric plastic material.

13. The removable and flappable, flexible covering of claim 12 which is made of an alpha-olefin polymeric plastic material.

14. The removable and flappable, flexible covering of claim 13 which is made of polypropylene.

15. The removable and flappable, flexible covering of claim 14 wherein the flexible fabric cover has a midline cut to allow independent wing flapping.

16. A disposable package that can be torn open in combination with a plurality of flexible fabric covers having the configuration of a plan view of a bird to be decoyed imprinted thereon;
each of said flexible fabrics having an adjustable and yieldable head hole for insertion over the head of a bird decoy, and each having a midline cut to allow independent wing flapping in the wind.

17. The package of claim 16 which has a mixture of flexible fabric coverings within the package, some of the male of the bird species to be decoyed and some of the female of the bird species to be decoyed.

18. The package of claim 16 which is all male birds of the species to be decoyed.

19. The package of claim 16 wherein the flexible coverings within said package are all females of the species to be decoyed.
